(19) United States
(12) Patent Application Publication
(10) Pub. No.: US 2014/0247160 A1
(43) Pub. Date: Sep. 4, 2014

(54) SYSTEMS AND METHODS FOR TRAFFIC SIGNAL WARNING

(71) Applicant: Sandra J. Glascock, Rixeyville, VA (US)

(72) Inventor: Sandra J. Glascock, Rixeyville, VA (US)

(21) Appl. No.: 13/782,814

(22) Filed: Mar. 1, 2013

(51) Int. Cl. G08G 1/095

(52) U.S. Cl. CPC G08G 1/095
USPC 340/907

(57) ABSTRACT

Systems and methods for traffic signal warning are provided. An example system allows using a camera mounted in front of a vehicle to continuously scan a space in front of the vehicle to detect impending traffic signals and show them on a display disposed at a back of the vehicle to inform other trailing vehicles about traffic conditions in front of the vehicle. The system may allow a driver of a trailing vehicle, for example, to see which traffic light is going to turn at the present moment, or whether there is a speed limitation on the upcoming road segment. The detected traffic signals may be displayed in several different ways, such as actual or simulated images, icons, a text, or a video, which are updated at predetermined intervals. Additionally, the system may comprise speakers to audibly communicate information about traffic conditions.

### TECHNICAL FIELD

This disclosure generally relates to warning systems and, more specifically, to methods and systems for alerting vehicles of changes in road conditions or impending traffic signals.

### BACKGROUND

Over 2,000 Americans are killed every year in automobile accidents occurring in intersections controlled by traffic signals, and more than 100,000 Americans are injured every year by such accidents. To the extent that these accidents involve smaller vehicles following larger ones, the risk of an accident is increased by the fact that larger vehicles obstruct the view of the drivers of smaller cars of traffic signals in front of the larger vehicles.

This common situation places the drivers and passengers of smaller vehicles at risk in two ways when the larger vehicle approaches a traffic signal that is turning red. If the driver of the larger vehicle attempts to quickly slow down so as to not go through a red light, the driver of the smaller car may not be able to react quickly enough to avoid crashing into the “suddenly” slowing larger vehicle. Alternatively, if the larger vehicle continues through the intersection, the driver of the following smaller car, unaware that the light has turned red, will pass into the intersection against a red traffic signal.

These risks could be significantly reduced if displays mounted on the rear of larger vehicles communicated the status of traffic signals in front of the larger vehicles.

### BRIEF DESCRIPTION OF THE DISCLOSURE

According to one or more example embodiments of the disclosure, there are provided methods and systems for traffic signal warning of vehicles in situations of restricted visibility, such as, for example, when larger vehicles obstruct the view of the drivers of smaller cars following the larger ones, and the drivers of smaller cars are not able to see the entire situation on the road and react quickly to avoid collision. Specifically, the methods and systems disclosed herein provide a technique for communicating a status of traffic signals to a trailing vehicle via a display mounted at a back of a leading vehicle. Thus, a driver of the trailing vehicle may be constantly informed of traffic conditions on the road in spite of obstacles encountered ahead.

According to various example embodiments, there is provided a camera or other forward-looking detection device that may continuously scan a space in front of a vehicle for traffic signals and traffic situations on a road. Additionally, a software may be provided to recognize traffic signals, identify their status, and transmit information about that status to a display at the back of the leading vehicle. The display may be mounted at the back of the leading vehicle and may be configurable to indicate the status of the detected traffic signal by certain means, such as, for example, by displaying an actual or simulated image of the status of traffic signals or activating and updating icons representing the status of the traffic signal at any given moment. Alternatively, a real-time video indicating the actual traffic situation in the field of view of the camera may be displayed via the display. Additionally one or more speakers may be optionally provided to audibly communicate the status of the traffic signals in addition to images represented by the display.

Additional systems, methods, apparatuses, features, and aspects are realized through the techniques of various embodiments of the disclosure. Other embodiments and aspects of the disclosure are described in detail below and are considered a part of the claimed disclosure. Other embodiments and aspects can be understood with reference to the description and the drawings.

### BRIEF DESCRIPTION OF THE DRAWINGS

Having thus described the disclosure in general terms, reference will now be made to the accompanying drawings, which are not necessarily drawn to scale, and wherein:

FIG. 1 is a schematic view of a road scene, which shows a vehicle having a traffic signal warning system mounted thereon.

FIG. 2 is an example embodiment of transmitting a detected traffic signal to a display.

FIG. 3 is an example flow diagram of a method for traffic signal warning.

FIG. 4 is a schematic view of a road scene, which shows a vehicle having a traffic signal warning system with speakers mounted thereon.

FIG. 5 shows example embodiments of representing detected traffic signals on a display.

### DETAILED DESCRIPTION

Illustrative embodiments of the disclosure now will be described more fully hereinafter with reference to the accompanying drawings, in which some but not all embodiments of the disclosure are shown. Indeed, the disclosure may be embodied in many different forms and should not be construed as limited to the embodiments set forth herein; rather, these embodiments are provided so that this disclosure will satisfy applicable legal requirements. Like numbers refer to like elements throughout.

Systems and methods disclosed herein enable a driver of a trailing vehicle to see the impending traffic signs that are obscured by a leading vehicle moving in front, such as a large car, a bus, a trolleybus, a truck and the like.

In some example embodiments, the warning system includes a detection device, which may be installed in front of a vehicle. The detection device may be a sensor, such as an image sensor, or a camera configured to take real time images of objects within the field of view of the camera. The detection device may be configured to capture real time video of the surrounding traffic movement. Those of skill in the art will appreciate that traffic signals and conditions may be detected or captured using any of a variety of different known technologies and techniques.

The term “traffic signal” as used herein refers to different conditions, signals and signs that regulate road traffic and are to be observed by all participants of road traffic, vehicles, passengers and pedestrians. Specifically, the term “traffic signal” may refer to various road signs, traffic-controller's signals, traffic light signals, road conditions, obstacles on the road, and so forth.

Systems and methods disclosed herein enable avoidance of collisions between cars in situations where larger vehicles obstruct the view of the drivers of smaller cars. Each car is equipped with a detection device to allow scanning a space in front of the car and detecting upcoming traffic signals. The detection device may be connected to a transmitter for transmitting the detected information to a display mounted at the rear end of the car. There is provided a software that recognizes traffic signals, identifies their status, and transmits the information about the status of traffic signals in front of the larger vehicles to a display mounted at the back thereof. Thereby, the driver of a smaller trailing vehicle may be able to see an impending traffic environment and the status of traffic signals by looking at the display mounted at the back of the leading vehicle. This approach enables the driver of the smaller vehicle to anticipate the behavior of the larger vehicle depending on the traffic situation in front thereof, especially when approaching intersections or other dangerous road sections.

In some example embodiments, the detection device may include a forward-looking camera configured to consecutively acquire images or video of the space in front of a leading vehicle in real time. The camera may be mounted in a passenger compartment and is configured to pick up information through a windshield. Alternatively, the camera may be placed outside the passenger compartment (for example, on a hood). In this case, the camera is enclosed within a protective element to protect it from external influences such as impacts or percussion.

In some example embodiments, the camera is arranged on a movably mounted pivot unit, which is connected to a drive unit. The camera may be moved by means of a movement of the pivot unit initiated by a drive unit.

In some example embodiments, the display may be mounted inside a vehicle, in particular, on a dashboard or panel board, to be seen by a driver. Each car is provided with a transmitter and a receiver. The driver of a trailing car may send a request signal via the transmitter to a leading vehicle to acquire information related to the traffic environment in front of the leading vehicle. Upon reception of the request signal, a receiver on the leading vehicle may activate a transmitter on the leading vehicle to send captured images to the display mounted inside the trailing car. The driver may adjust the request signal range to acquire the information from up to several leading cars. That is, the driver may set the range to allow receiving images from a car that is 35 feet ahead or so. This way, a driver may see what is happening far ahead of his car to avoid, for example, a traffic jam.

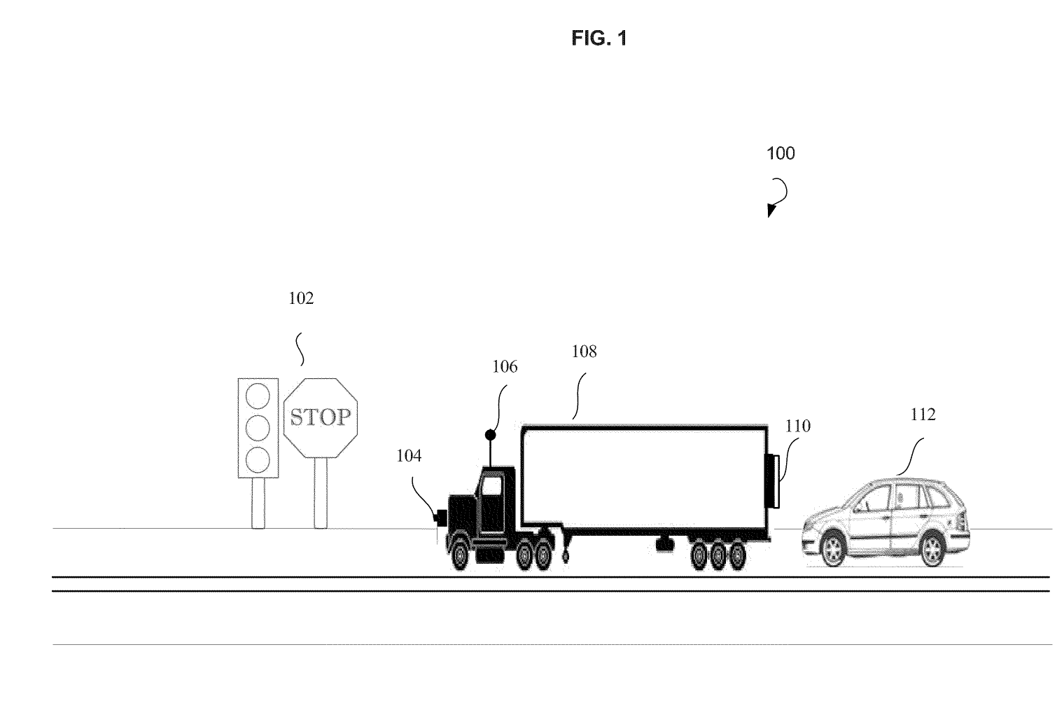

Referring now to the drawings, FIG. 1 shows a schematic view a road scene, which shows a vehicle having a traffic signal warning system 100 mounted thereon. As shown in FIG. 1, the system may include a detection device 104 disposed in front of a leading vehicle 108. The detection device 104 may be configurable to continuously scan a space in front of the leading vehicle 108 to detect traffic signals 102. The warning system 100 includes a transmitter 106 for transmitting the traffic signals 102 to a display 110 mounted at a back of the leading vehicle 108. The display 110 may be configurable to represent a status of the traffic signals 102 to a trailing car 112. As shown in FIG. 1, the leading vehicle 108 may partially or completely obstruct the road and the objects located thereon to the trailing car 112. The driver of the trailing car 112 may not be able to see the stoplight 102 to react accordingly to the switching of lights. In this case, the driver of the trailing car 112 may look at the display 110 mounted at the back of the leading car 108 to determine the current status of the stoplight 102 and decide whether to slow down or speed up.

The warning system 100 may include a processing logic that may process images captured by the detection device to recognize traffic signals, identify their status, and transmit information about the status to the display at the back of the vehicle. In one example embodiment, the processing logic resides at the controller (not shown), which may be mounted on a vehicle. It will be appreciated by one of ordinary skill in the art that instructions said to be executed by the controller may, in fact, be retrieved and executed by one or more processors. The controller may also include memory cards, servers, and/or computer discs. Although the controller may be configured to perform one or more steps described herein, other control units may be utilized while still falling within the scope of various embodiments.

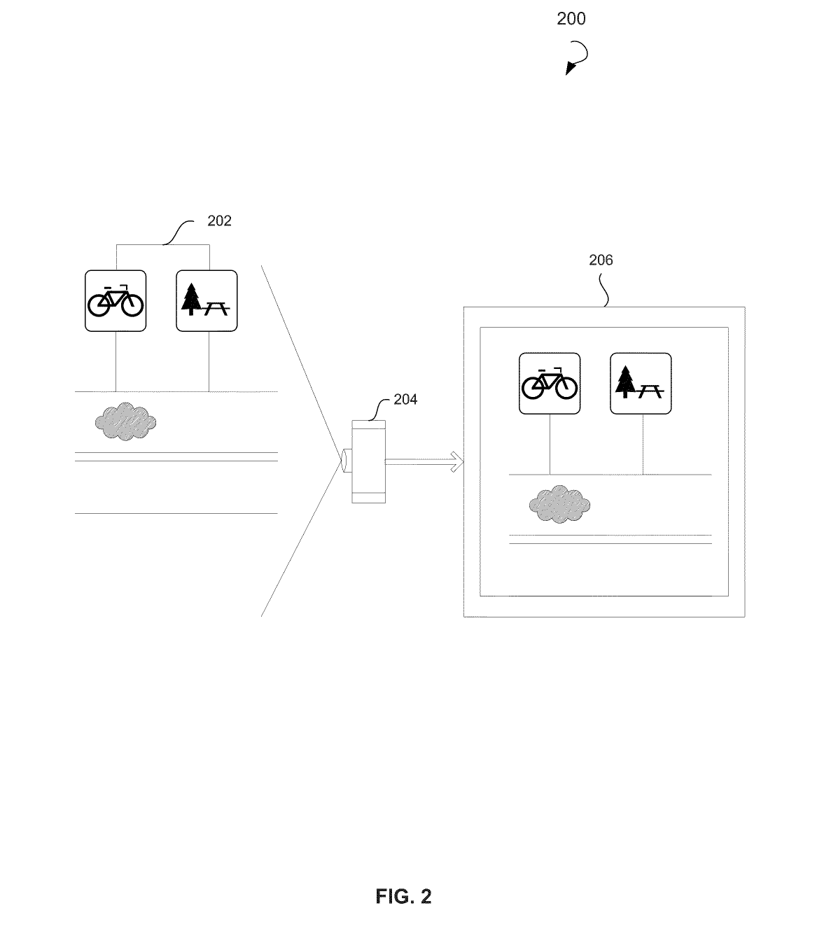

FIG. 2 shows an example embodiment of transmitting a detected traffic signal to a display. As shown in FIG. 2, detection device 204 scans the surroundings in front of a vehicle and take images of traffic signals 202. The detection device 204 may be a photo camera, a video camera, an image sensor, and so forth. According to one example embodiment, the detection device 204 may be configured to capture real-time video of a traffic situation at a given moment in time. The captured information may be thereafter processed or converted into suitable format to be displayed on display 206. The traffic signal may be displayed on a display screen 206 in the form of a video, an actual or simulated image, a text, and so forth.

According to some example embodiments, the video data indicating a traffic scene image may be transmitted from the detection device 204 to the display 206 through a cable at a high speed, and the traffic scene image may be displayed on the display 206 at real time.

According to some example embodiments, the captured video data indicating the traffic scene may be stored in a video data storing unit arranged in the vehicle.

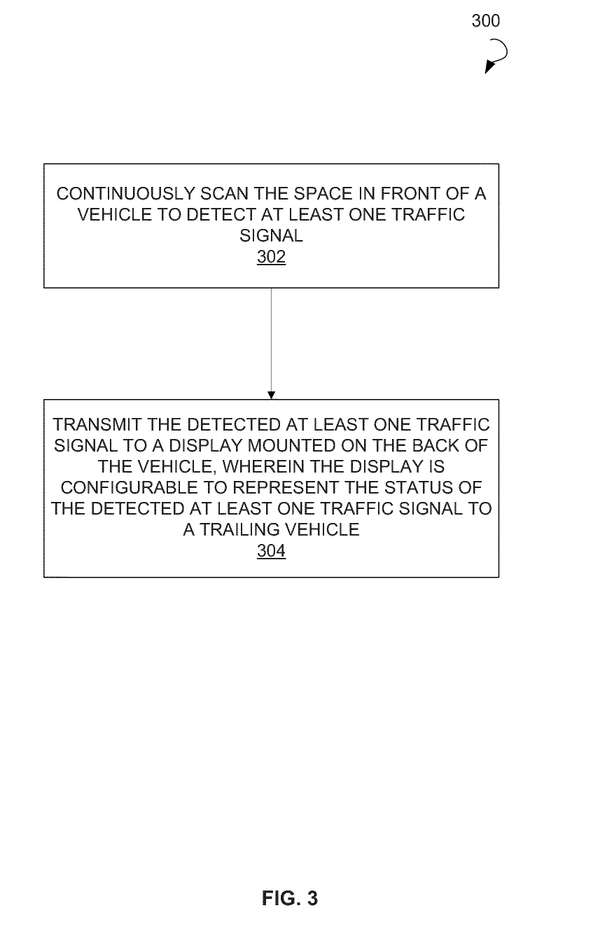

FIG. 3 shows an example flow diagram of a method 300 for traffic signal warning, according to one or more embodiments of the disclosure. The method 300 may be implemented by system 100 as described above with reference to FIGS. 1-2.

The method 300 may commence in operation 302 with a detection device continuously scanning a space in front of a leading vehicle to detect at least one traffic signal. In operation 304, the at least one traffic signal may be transmitted to a display mounted at a back of the leading vehicle. The display may be configurable to represent a status of the at least one traffic signal to a trailing vehicle moving behind the leading vehicle.

The method may further comprise emitting, via one or more speakers, audible signals associated with traffic signals detected by the detection device. This will be helpful in the situations, for example, when the display gets muddy or broken.

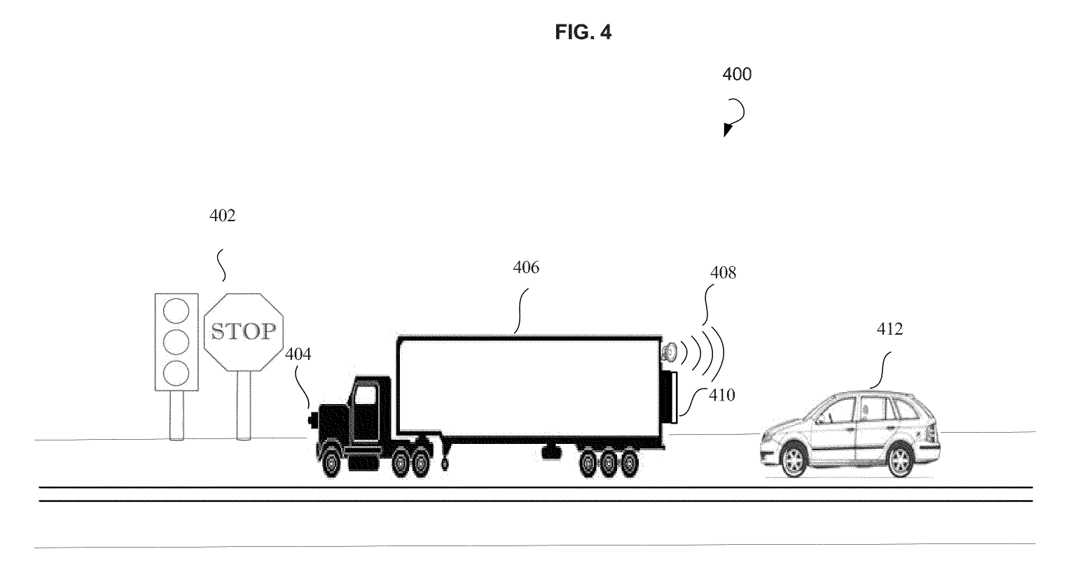

FIG. 4 shows a schematic view of a road scene, which shows a vehicle having a traffic signal warning system with speakers mounted thereon. As shown in FIG. 4, the road scene is similar to that of FIG. 1. However, the traffic signal warning system of FIG. 4 additionally includes an audio system as an additional means for communicating information relating to the traffic environment and signals to one or more drivers of neighboring trailing vehicles. An audible signal may be helpful when, for example, a monitor at a back of a leading vehicle is muddy or broken, or there are low visibility conditions. The audible signal may also be effective for the drivers of neighboring vehicles, who are not able to see the screen of a leading vehicle, and also to pedestrians who intend to cross a road.

An audible signal may be a sound warning signal of relatively low volume or having a higher volume. An amplitude and frequency of sound may be based on a driving area (city driving or highway driving), speed of a vehicle, type of a vehicle, and so forth. The audible signal may be activated if the vehicle collides with an object (e.g., another vehicle), or suddenly stops, turns, or makes an abrupt maneuver. Alternatively, an audible signal may be emitted at predefined situations (for example, at intersections or near traffic lights).

In some example embodiments, an audible signal may be in the form of vocalized words relating to specific traffic environments, traffic signals, traffic lights, and so forth. Such words may be prerecorded, stored in a database, and vocalized in predetermined situations. The audible signal may be emitted alone or in addition to images displayed on a display screen.

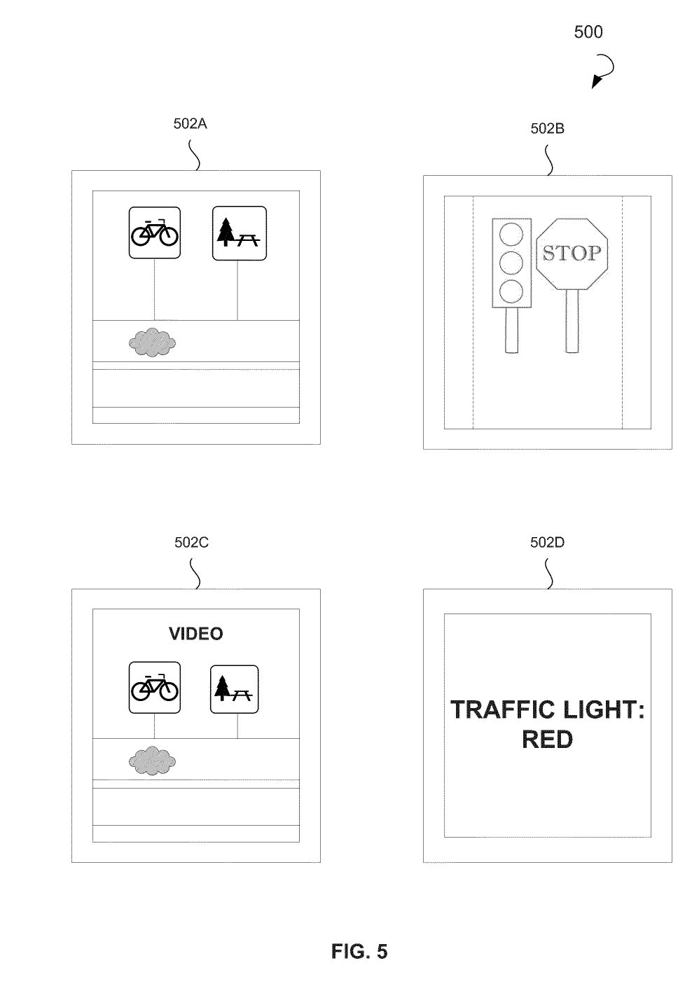

FIG. 5 shows example ways of representing detected traffic signals on a display. As shown in FIG. 5, traffic signals may be represented as an actual image 502A, a simulated image 502B, a video 502C, and a text 502D.

Images or video captured by a camera may be stored in a memory of a controller and further processed to be displayed on a display screen in different forms.

The actual image 502A may be a real-time photograph or a portion of a photograph. The photographs may be dynamically updated at predetermined time intervals to show the actual situation on the road.

In some example embodiments, the actual image 502A may be processed by an image processor to be represented as a simulated image 502B. The simulated image 502B may have a lower resolution than the actual image 502A and may include only the most important objects of the traffic environment that would reflect an overall picture thereof.

In some example embodiments, a video data indicating a traffic scene in front of a vehicle may be produced by a video camera and may be compressed and transmitted to the display screen through a communication line at high speed. The transmitted video data may be expanded and displayed as a real-time video 502C on the display screen.

In some example embodiments, the display may reflect only icons of traffic signs or traffic lights or text describing the traffic situation. The text may specify different traffic signs, traffic lights, and traffic conditions, such as “a pothole” or “a car accident.” The text may also include a predefined recommended action, such as “slow down” or “stop.”

Although the embodiments have been described with reference to specific example embodiments, it will be evident that various modifications and changes can be made to these example embodiments without departing from the broader spirit and scope of the present application. Accordingly, the specification and drawings are to be regarded in an illustrative rather than a restrictive sense.

What is claimed is:

1. A traffic signal warning system, comprising:
at least one detection device configurable to continuously scan a space in front of a vehicle to detect at least one traffic signal; and
a transmitter for transmitting the at least one traffic signal to a display mounted at a back of the vehicle, wherein the display is configurable to represent a status of the at least one traffic signal to a trailing vehicle.

2. The system of claim 1, wherein the at least one detection device is further configured to take images of the at least one traffic signal.

3. The system of claim 1, wherein the at least one detection device includes: a photo camera, video camera, and image sensor.

4. The system of claim 1, wherein the at least one traffic signal includes: a road sign, a road condition, an obstacle on a road, a traffic-controller's signal, and a traffic light signal.

5. The system of claim 1, wherein the at least one traffic signal is displayed in the form of a video, or an actual or simulated image.

6. The system of claim 1, wherein the display is further configured to represent a current velocity or change in the velocity of the vehicle.

7. The system of claim 1, wherein the display includes at least one speaker configured to emit audible signals associated with the at least one traffic signal.

8. The system of claim 1, wherein the display is further configured to update images representing the status of the at least one traffic signal at predetermined intervals.

9. The system of claim 1, wherein the display is further configured to output a signal to warn the trailing vehicle about upcoming traffic conditions in front of the vehicle.

10. The system of claim 1, wherein the display is integrated into a rear window of the vehicle.

11. A traffic signal warning method comprising:
continuously scanning a space in front of a vehicle to detect at least one traffic signal; and
transmitting the at least one traffic signal to a display mounted at a back of the vehicle, wherein the display is configurable to represent a status of the at least one traffic signal to a trailing vehicle.

12. The method of claim 11, wherein the at least one detection device is further configured to take images of the at least one traffic signal.

13. The method of claim 11, wherein the at least one detection device includes: a photo camera, video camera, and image sensor.

14. The method of claim 11, wherein the at least one traffic signal includes: a road sign, a road condition, an obstacle on a road, a traffic-controller's signal, and a traffic light signal.

15. The method of claim 11, wherein the at least one traffic signal is displayed in the form of a video, or an actual or simulated image.

16. The method of claim 11, further comprising representing on the display a current velocity or change in the velocity of the vehicle.

17. The method of claim 11, further comprising emitting through at least one speaker audible signals associated with the at least one traffic signal.

18. The method of claim 11, further comprising updating on the display images representing the status of the at least one traffic signal at predetermined intervals.

19. The method of claim 11, further comprising outputting via the display a signal to warn the trailing vehicle about upcoming traffic conditions in front of the vehicle.

20. A traffic signal warning system comprising:
at least one forward-facing camera system disposed in front of a vehicle and configurable to continuously scan a space within a field of view of the camera system to detect at least one traffic signal;
a transmitter for transmitting the at least one traffic signal to a display mounted at a back of the vehicle, wherein the display is configurable to represent a status of the at least one traffic signal to a trailing vehicle;
updating on the display images representing the status of the at least one traffic signal at predetermined intervals.
